(19) United States
(12) Patent Application Publication
(10) Pub. No.: US 2020/0259891 A1
(43) Pub. Date: Aug. 13, 2020

(54) Facilitating Interaction with Plural BOTs Using a Master BOT Framework

(71) Applicant: Microsoft Technology Licensing, LLC, Redmond, MA (US)

(72) Inventor: Robin ABRAHAM, Redmond, WA (US)

(21) Appl. No.: 16/269,571

(22) Filed: Feb. 7, 2019

(51) Int. Cl. H04L 29/08; H04L 12/58

(52) U.S. Cl. CPC H04L 67/1008; G06F 17/2785; H04L 51/02

(57) ABSTRACT

A computer-implemented technique is described herein which uses a master BOT framework to facilitate a user's interaction with plural BOTs. The BOT framework includes a BOT registry that stores information regarding a plurality of BOTs that may be activated to handle different tasks (and associated intents). The BOT framework also includes various components that facilitate the transition from one BOT to another in the course of a multi-BOT transaction. According to one technical feature, the technique automatically invokes a new BOT without requiring the user to explicitly identify it. This provision simplifies the user's activation of a new BOT. According to another feature, the technique automatically forwards current state information to the new BOT. This provision expedites the user's transaction because it reduces the need for the user to repeat information that has already been supplied in one more prior turns of the transaction.

### BACKGROUND

A chatbot, or BOT for brevity, refers to a computer-implemented agent that provides a service to a user via a conversational interface. In operation, the user submits one or more input expressions to the BOT in a natural language. The BOT formulates a response to each input expression, also expressed in the natural language. Many BOTs primarily allow a user to retrieve information in selected domains of knowledge. In addition, or alternatively, a BOT may allow a user to perform additional actions, such as making reservations, placing orders, controlling equipment, etc.

In some cases, a user successively interacts with plural BOTs in performing a transaction. For example, a user may search for, invoke, and then interact with a first BOT to perform a first part of a transaction. The user may then search for, invoke, and interact with a second BOT to perform a second part of the transaction. These two BOTs are typically produced by different developers, and therefore operate in standalone fashion. The dialogues that the user conducts with these two BOTs can likewise be viewed as separate standalone conversations.

In some systems, a user can activate a BOT in a messaging application by explicitly referencing its name, e.g., prefaced by the “@” symbol. This provision allows a user to quickly invoke a BOT. But it presupposes that: (a) the user already has advance knowledge of the existence of the BOT; and (b) that the user remembers the name by which the BOT can be invoked. If these conditions are not met, the user will need to perform research on the desired BOT before invoking it in a chat session.

### SUMMARY

A computer-implemented technique is described herein which uses a master BOT framework to facilitate a user's interaction with plural BOTs. The BOT framework includes a BOT registry that stores information regarding a plurality of BOTs, produced by different developers. The BOT framework also includes various components that facilitate the transition from one BOT to another in the course of a multi-BOT transaction performed by a user.

In one manner of operation, the technique receives a current utterance of a user who is interacting with a current BOT to perform a transaction of any kind. It then assesses a current intent of the user, as well as the current state of the transaction. The current intent expresses an objective that the user is attempting to accomplish at a present time. The current state expresses the user's current progress towards that objective. The technique then determines, based on at least the current intent, whether the current BOT is capable of handling the current utterance. If not, the technique queries the BOT registry to find a new BOT that is capable of handling the current utterance. The technique then passes at least the current utterance to the new BOT, along with information that expresses the current state; that information, in turn, may incorporate information gleaned from one or more prior turns (if any) of the transaction.

According to one technical feature, the technique automatically invokes a new BOT without requiring the user to explicitly identify it. This provision expedites the user's activation of a new BOT, e.g., by eliminating the need for the user to manually search for and invoke the new BOT, or identify the new BOT by explicitly specifying its name (e.g., using the “@” symbol). Further, the technique automatically forwards current state information to the new BOT. This provision expedites the user's transaction because it reduces the need for the user to repeat information that has already been supplied in one more prior turns of the transaction. Overall, the technique can reduce the number of turns in a transaction, thereby offering good user experience and accommodating the efficient use of computing resources.

The above-summarized technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of a computing environment that uses a master BOT framework to facilitate a multi-BOT transaction performed by a user.

FIG. 2 shows a first implementation of the master BOT framework that uses a master-slave topology.

FIG. 3 shows a second implementation of the master BOT framework that uses a peer-to-peer topology.

FIG. 4 shows an example of the use of the master BOT framework shown in FIG. 1, with respect to the master-slave topology of FIG. 2.

FIG. 5 shows one implementation of a routing component, which is an element of the master BOT framework of FIG. 1.

FIG. 6 shows a data store for storing information regarding BOTs in a BOT registry. The BOT registry, in turn, corresponds to another element of the master BOT framework of FIG. 1.

FIG. 7 shows a registry BOT selection component, corresponding to an element of the BOT registry.

FIG. 8 shows one implementation of an intent-monitoring component, corresponding to another element of the master BOT framework of FIG. 1.

FIG. 9 shows one implementation of a context-monitoring component, corresponding to another element of the master BOT framework of FIG. 1.

FIG. 10 shows one implementation of a feedback-monitoring component, corresponding to another element of the master BOT framework of FIG. 1.

FIG. 11 shows an illustrative BOT, corresponding to any BOT that may interact with the master BOT framework of FIG. 1.

FIG. 12 shows an illustrative Convolutional Neural Network (CNN) component, representing one type of machine-trained component that can be used in the master BOT framework of FIG. 1.

FIG. 13 shows an illustrative Recurrent Neural Network (RNN) component, representing another type of machine-trained component that can be used in the master BOT framework of FIG. 1.

FIGS. 14 and 15 together show a flowchart that describes one illustrative manner of operation of master BOT framework of FIG. 1.

FIG. 16 is a flowchart that describes one illustrative manner of training one or more machine-trained models used by the master BOT framework of FIG. 1.

FIG. 17 shows an illustrative type of computing device that can be used to implement any aspect of the features shown in the foregoing drawings.

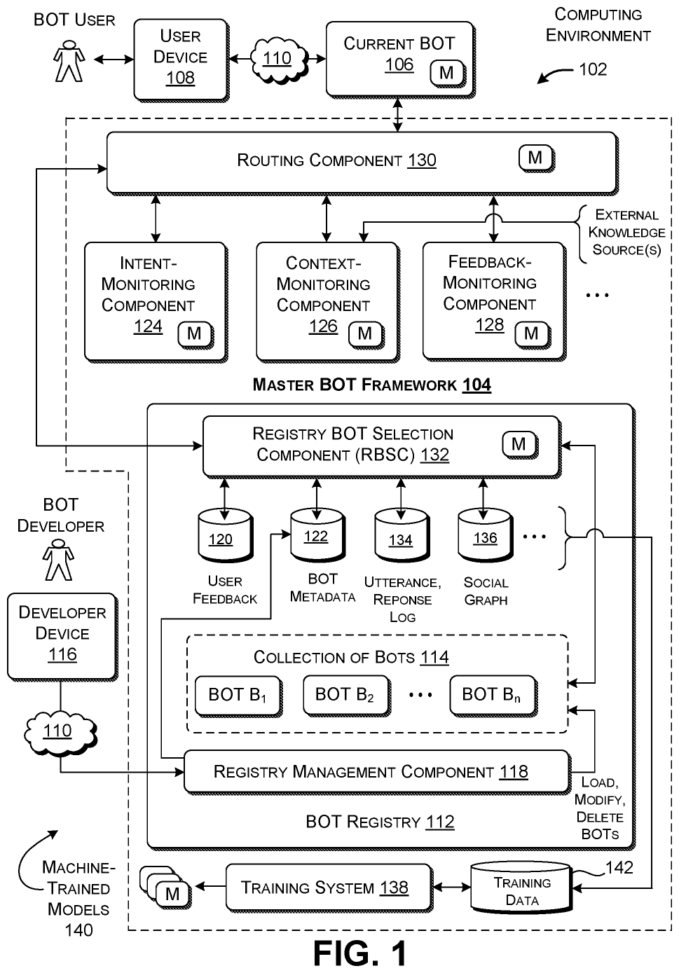

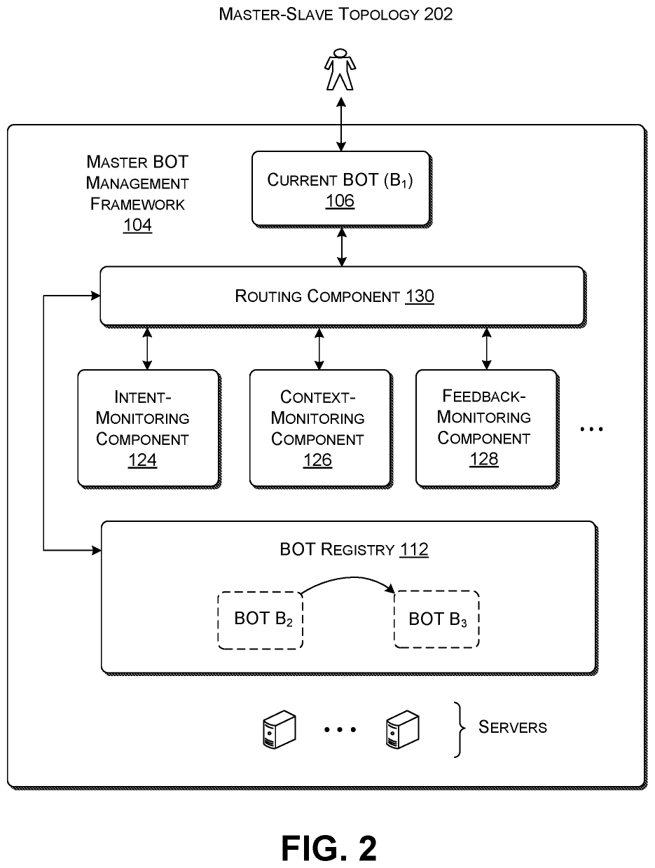

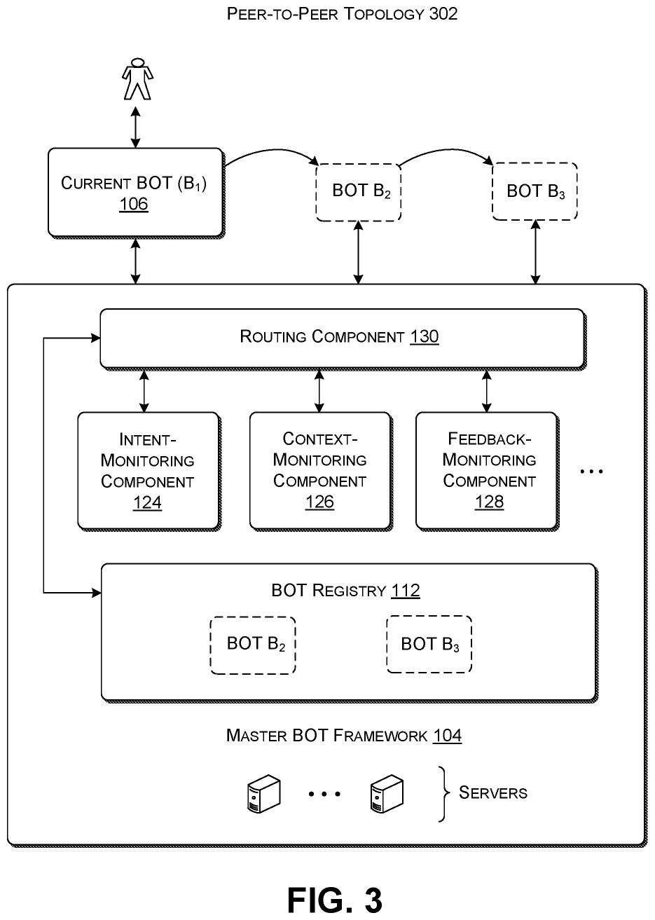

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computing environment that facilitates a user's transition among BOTs in the course of conducting a multi-BOT transaction. Section B sets forth illustrative methods which explain the operation of the computing environment of Section A. And Section C describes illustrative computing functionality that can be used to implement any aspect of the features described in Sections A and B.

As a preliminary matter, the term “hardware logic circuitry” corresponds to one or more hardware processors (e.g., CPUs, GPUs, etc.) that execute machine-readable instructions stored in a memory, and/or one or more other hardware logic components (e.g., FPGAs) that perform operations using a task-specific collection of fixed and/or programmable logic gates. Section C provides additional information regarding one implementation of the hardware logic circuitry. Each of the terms “component” and “engine” refers to a part of the hardware logic circuitry that performs a particular function.

In one case, the illustrated separation of various parts in the figures into distinct units may reflect the use of corresponding distinct physical and tangible parts in an actual implementation. Alternatively, or in addition, any single part illustrated in the figures may be implemented by plural actual physical parts. Alternatively, or in addition, the depiction of any two or more separate parts in the figures may reflect different functions performed by a single actual physical part.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by the hardware logic circuitry described in Section C, which, in turn, can be implemented by one or more hardware processors and/or other logic components that include a task-specific collection of logic gates.

As to terminology, the phrase “configured to” encompasses various physical and tangible mechanisms for performing an identified operation. The mechanisms can be configured to perform an operation using the hardware logic circuity of Section C. The term “logic” likewise encompasses various physical and tangible mechanisms for performing a task. For instance, each processing-related operation illustrated in the flowcharts corresponds to a logic component for performing that operation. A logic component can perform its operation using the hardware logic circuitry of Section C. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

### A. Illustrative Computing Environment

### A.1. Overview of the Master BOT Framework

FIG. 1 shows an overview of a computing environment 102 that includes a master BOT framework 104. The master BOT framework 104 constitutes a computer-implemented service that assists a user in conducting a transaction using one or more BOTs, in part, by facilitating the transition between BOTs in a multi-BOT transaction. As used herein, a BOT refers to any type of computer-implemented agent that performs any type service to a user via a natural language conversational interface.

In the scenario shown in FIG. 1, a user is currently interacting with a BOT 106 (referred to herein as the “current BOT”) via a user device 108 over a computer network 110. FIG. 1 indicates that the current BOT 106 is not itself considered a part of the master BOT framework 104. As described more fully in the context of FIG. 2, however, the current BOT 106 can alternatively operate as a master BOT that may be considered as a component of the master BOT framework 104. At this juncture of the explanation, assume that current BOT 106 represents whatever computer-implemented agent that the user happens to be interacting with at the current time, whether a component of the master BOT framework 104 or not.

The user device 108 corresponds to any electronic component that includes an input device that captures natural language expressions by the user, and which supplies natural language responses provided by the current BOT 106 via an output device. For instance, the user device 108 may correspond to a user computing device having one or more input devices and one or more output devices. That user computing device may correspond, for example, to any of: a desktop computing device; a laptop computing device; a handheld computing device of any type (such as a smartphone, a tablet-type computing device, etc.); a mixed-reality computing device; a wearable computing device; a vehicle-borne computing device, and so on. The computer network 110 may correspond to a wide area network (such as the Internet), a local area network, one or more point-to-point communication links, etc., or any combination thereof.

To facilitate explanation, the following description will assume that a user supplies an input linguistic expression in spoken form as an utterance. In this case, the user device 108 receives the user's linguistic expressions via a microphone, and provides the BOT's responses to a speaker. But in other cases, the user may supply input linguistic expressions in textual form, e.g., by typing them on a key input device. Similarly, any BOT can deliver its responses in text-based form on a display device. Further note that the user can interact with the current BOT 106 using any communication application, such as a voice-based communication application, a text-based messaging-type application, an Email application, etc.

In one implementation, the master BOT framework 104 and the current BOT 106 can be implemented by one or more servers, provided at a single location or distributed over plural locations. In another implementation, any component of the master BOT framework 104 and/or the current BOT 106 can be implemented by one or more local computing devices (that is, local with respect to the position of the user). For instance, any component of the master BOT framework 104 and/or the current BOT 106 can be implemented by the user device 108 itself

The master BOT framework 104 includes a BOT registry 112 for storing instances of code which implement a collection of BOTs 114 (B₁, B₂, . . . , Bₙ). These BOTs 114 perform different respective functions, and may be produced by different respective developers. FIG. 1, for instance, shows a scenario in which a BOT developer interacts with a developer device 116 to add a new BOT to the BOT registry 112, or delete a previously uploaded BOT, or modify a previously uploaded BOT, etc. The developer device 116 can correspond to any type of computing device mentioned above. The developer device 116 interacts with the BOT registry 112 via the computer network 110, such as the Internet.

A registry management component 118 performs various environment-specific functions to manage the collection of BOTs 114. For instance, the registry management component 118 can test each newly submitted BOT to ensure that it satisfies various environment-specific criteria. For example, the registry management component 118 can test each submitted BOT to ensure that it is free from malicious code. Further, the registry management component 118 can examine each submitted BOT to ensure that it performs a permitted function within a permitted domain. The registry management component 118 can perform this task by determining whether the submitted BOT is present on a whitelist list that identifies permitted BOTs and/or permitted BOT functions. Once a BOT is accepted, the registry management component 118 can periodically test the BOT to ensure that it is performing its assigned task in a satisfactory manner.

The registry management component 118 can also manage the collection of BOTs 114 based on user feedback information stored in a data store 120. As will be described below, the user feedback information expresses the level of satisfaction that users exhibit with the BOTs 114. For example, the registry management component 118 can remove a BOT that has an average rating score below a prescribed threshold. Or the registry management component 118 can modify a weighting value associated with a BOT based on its rating score. That weighting value either promotes or discounts the relevance of each BOT.

The registry management component 118 also accepts supplemental BOT-related information regarding each BOT provided by a developer, which it stores in a data store 122. For instance, the registry management component 118 can accept metadata that describes the intent(s) serviced by a newly uploaded BOT. As used herein, an “intent” refers to a goal or task that a BOT is designed to handle through interaction with the user. For instance, a movie-related BOT may encompass a first intent associated with the retrieval of movie-related information, a second intent associated with the purchase of a movie, and a third intent associated with the playback of a purchased movie.

In addition, or alternatively, the BOT-related information can include examples of user utterances handled by each BOT in the BOT registry 112, optionally together with the BOT responses provided by the BOT in response to these utterances. Each BOT developer can supply these examples when it uploads the BOT's code to the BOT registry 112. As will be described below, the master BOT framework 104 can leverage these examples, along with other information, to produce machine-trained models. The master BOT framework 104 uses these models, in turn, to perform its various functions. FIG. 1 generically represents the decision-making logic associated with each component by the symbol “M,” which may correspond to a machine-trained model, a rules-based engine, etc., or any combination thereof.

The master BOT framework 104 also includes a suite of components configured to perform real-time analysis on the user's conversation with the current BOT 106. For instance, an intent-monitoring component 124 monitors the intent associated with the user's current utterance, which the user submits to the current BOT 106. Again, the intent refers to the objective that the user is apparently attempting to accomplish at a current point in time. A context-monitoring component 126 determines the current state associated with whatever transaction the user is currently performing. The current state reflects how far the user has progressed in completing his or her objective. The current state, in turn, may incorporate information gleaned from one or more prior turns of the current transaction (and/or an earlier transaction) which is deemed relevant to the current state. For instance, the current state can incorporate information that the user has previously conveyed in the transaction, and/or information that the current BOT 106 (or any other BOT) has previously supplied to the user. A feedback-monitoring component 128 captures information that expresses the user's satisfaction with the current BOT 106 at the current time. For instance, the feedback-monitoring component 128 can glean the user's satisfaction based on explicit rating information supplied by the user. In addition, or alternatively, the feedback-monitoring component 128 can use a sentiment-monitoring component to infer the user's satisfaction based on the user's current utterance. Later subsections will provide additional details regarding each of these components (124, 126, 128).

A routing component 130 operates as a central agent which manages a user's conversation with one or more BOTs, and which coordinates the interaction of each BOT with the master BOT framework 104. In one manner of operation, the routing component 130 receives a current utterance that the user has submitted to the current BOT 106. It then calls on the intent-monitoring component 124 to determine the intent of this utterance (referred to below as the “current intent”). It also calls on the context-monitoring component 126 to update the current state of the transaction to reflect the current utterance. It can optionally also call on the feedback-monitoring component 128 to gauge the user's satisfaction with the transaction at the current time, as expressed in the current utterance. Based on any part(s) of this collected evidence, the routing component 130 determines whether the current BOT 106 is capable of handling the current utterance. Additional information is provided below that explains how the routing component 130 can perform this function.

Assume that the routing component 130 concludes that the current BOT 106 cannot successfully handle the user's current utterance. In response, the routing component 130 interacts with the BOT registry 112 to find one or more new BOTs that can address the user's current utterance. The routing component 130 can then select at least one of these new BOTs. For example, if the BOT registry 112 identifies n suitable new BOTs, the routing component 130 can select the BOT from this set having the best ranking score. In addition, or alternatively, the routing component 130 can select a BOT from this set which the user has previously designated as the most preferable. The user's preference settings may be stored in the data store 120.

The routing component 130 then orchestrates the transition from the current BOT 106 to the new BOT that it has just selected. In one implementation, the routing component 130 performs this task by passing the current utterance to the new BOT, together with current state information provided by the context-monitoring component 126. The current state information, as described above, may capture information that the user has already supplied in the transaction (via interaction with the current BOT 106) that is relevant to the user's current intent. In addition, or alternatively, the current state information may capture information from one or more prior transactions. In addition, or alternatively, the current state information may capture information regarding the user's profile and/or the user's stored preference information, etc.

For example, assume that the current BOT 106 is a weather-related BOT. Further assume that, in response to the user's query, the weather-related BOT informs the user that it is currently snowing in a region of the country through which a highway runs. Assume that the user next asks the current BOT 106 to estimate the travel time between specified cities linked by that highway. The routing component 130 may conclude that the current BOT 106 cannot handle this question. In response, the routing component 130 interacts with the BOT registry 112 to finding a suitable travel-related BOT, which it then invokes. The routing component 130 then forwards the user's current utterance to the travel-related BOT, along with relevant state information. Here, the state information indicates that snow is currently falling on the highway under consideration. This item of previously-supplied information is relevant because it will impact the travel-related BOT's computation of the travel time. By virtue of this approach, the travel-related BOT does not need to explicitly ask the user to specify the weather conditions that may affect the route selected by the user.

To perform the above functions, the BOT registry 112 includes a registry BOT selection component (RBSC) 132 that suggests one or more new BOTs based on information provided by the routing component 130. More specifically, the input information fed to the RBSC 132 can include any of: the current utterance, the current intent information, the current state information, etc. The output of the RBSC 132 may correspond to a set of identifiers associated with respective BOTs. In one implementation, the RBSC 132 can perform its mapping function using a machine-trained model. A later subsection will provide additional details regarding how the RBSC 132 can perform its function.

In addition to user feedback information (provided in the data store 120) and BOT-related information (provided in the data store 122), the BOT registry 112 can store a log of previous conversations between users and BOTs, which it maintains in a data store 134. The BOT registry 112 can optionally organize this log by providing a file of conversations associated with each user (if authorized by each such user). The BOT registry 112 can also store social graph information in a data store 136. The social graph information identifies relationships among people, including those users who interact with the BOTs 114. The RBSC 132 can rely on any information in these data stores (120, 122, 134, 136) in determining a set of n BOTs that can be used to handle a current utterance.

A training system 138 produces one or more machine-trained models 140 based on training examples provided in a data store 142. The master BOT framework 104, in turn, can harvest the training examples from the information provided in the above-described data stores (120, 122, 134, 136). Generally note that the information captured in the data stores (120, 122, 134, 136) describes the behavior of all of the BOTs 114 associated with the BOT registry 112. The information in these data stores (120, 122, 134, 136) can therefore be viewed as a global resource for use in managing a plurality of BOTs. The information accordingly has a broader scope than the training set used by a developer to train any individual BOT.

The training system 138 can use any training techniques to produce its models 140. For instance, without limitation, the training system 138 can use the gradient descent technique to train at least some of the models, based on the training examples in the data store 142. To generate a model for use by the intent-monitoring component 124, for example, the training system 138 can attempt to iteratively reduce the discrepancies between the known intent-related classification of user utterances, and the model's classification of those same utterances.

FIG. 2 shows a first implementation of the master BOT framework that uses a master-slave topology 202. In this configuration, the current BOT 106 functions as a persistent master BOT through which the user interacts throughout a multi-BOT transaction. In operation, the current BOT 106 will continue to answer the user's utterances until the routing component 130 discovers that the user has submitted an utterance that the current BOT 106 is not equipped to handle. The routing component 130 will then invoke another BOT from the BOT registry 112 in the manner described above. But that other BOT will feed its BOT responses to the user through the conversational interface of the current BOT 106. That is, if a new BOT issues a response, the routing component 130 will forward that response to the current BOT 106, whereupon the current BOT 106 will forward it to the user. In this manner of operation, the current BOT 106 delegates the task of answering the user's utterances to a new BOT, but still operates as the front-facing interface through which the user interacts.

Note that each BOT has its own distinctive “personality.” Hence, although the current BOT 106 serves as the user's sole access point throughout a multi-BOT transaction, the user may notice a change in the nature of a conversation when the current (master) BOT 106 begins receiving responses from a new BOT. This change may manifest itself in the kind of information that is provided to the user, and/or the manner in which that information is formulated. Otherwise, the master BOT framework 104 need not explicitly notify the user of the identity of the underlying BOT that is providing each response. In other implementations, however, the master BOT framework 104 can include information in its responses which explicitly notifies a user of the identity of the BOT that is currently providing a response. In some implementations, the user can control the notification-related behavior of the master BOT framework 104, e.g., through a user-selected configuration setting.

In one implementation, the current BOT can be considered as part of the general services provided by the master BOT framework 104. For example, the current BOT 106 can correspond to a general-purpose virtual assistant. That general-purpose virtual assistant performs several tasks associated with several respective intents. In that case, the routing component 130 only calls on another BOT when it determines that the virtual assistant has encountered an utterance that it cannot successfully address.

FIG. 3 shows a second implementation of the master BOT framework 104 that uses a peer-to-peer topology 302. In this configuration, when the routing component 130 determines that the current BOT 106 cannot handle the user's current utterance, it delegates control to a new BOT (such as BOT B₂) in the same manner described above. Unlike the master-slave topology 202, however, the user henceforth interacts directly with the new BOT, which assumes the role of the current BOT. The previous current BOT 106 is deactivated at this point, or otherwise remains idle.

The BOTs in FIG. 3 can be conceptualized as operating “outside” the master BOT framework 104 in the sense that these BOTs rely on the services of the master BOT framework 104, but do not otherwise operate as components within the master BOT framework. In other words, the current BOT 106 in the context of FIG. 3 does not provide an across-BOT service similar to the current (master) BOT 106 in the master-slave topology 202 of FIG. 2. But note that, in both topologies (202, 302), the BOT registry 112 can continue to store the code and BOT-related information associated with the BOTs. Moreover, the same servers that implement the various components of the master BOT framework 104 can run the code associated with the individual BOTs.

Regardless of what topology of used, different implementations of the master BOT framework 104 can place different design-related expectations on the developers of individual BOTs. In a first implementation, the master BOT framework 104 places no constraints on the design of the individual BOTs. For example, a developer may produce a framework-agnostic BOT for use in making restaurant reservations, and subsequently upload that BOT to the BOT registry 112 of the master-slave topology 202 shown in FIG. 2. While this framework-agnostic BOT will henceforth work within the master BOT framework 104 in the manner described above, the developer need not incorporate special code in the framework-agnostic BOT that depends on the functionality provided by the master BOT framework 104. The framework-agnostic BOT would also work as a standalone BOT with which the user directly interacts. The framework-agnostic BOT itself has no awareness of the environment in which it is being fed input utterances.

The peer-to-peer topology 302 of FIG. 3 can likewise interact with a framework-agnostic BOT. In that context, the routing component 130 can intercept utterances sent to the framework-agnostic BOT. It can likewise intercept responses generated by the framework-agnostic BOT. The routing component 130 can activate and deactivate the framework-agnostic BOT based on its analysis of the utterances fed to it, and the responses given by the BOT. Again, the master BOT framework 104 does not require changes to the internal logic provided by the framework-agnostic BOT. That BOT can continue to assume that it is operating in a standalone manner, without the services of the master BOT framework 104.

The above-described aspect of the master BOT framework 104 is desirable because it allows the BOT registry 112 to accept many different kinds of BOTs, including BOTs that that were designed with no consideration of their use in the master BOT framework 104. This aspect also simplifies the task of developing BOTs.

But in other implementations, a BOT developer can include one or more features in a BOT design that facilitate the interaction of the BOT with the master BOT framework 104. For example, a BOT developer can design a BOT such that it can more effectively utilize the current intent information, current state information, and/or feedback information provided by the master BOT framework 104. Alternatively, or in addition, a BOT developer can design a BOT such that it explicitly forwards received utterances and/or its generated responses to the master BOT framework 104. In addition, or alternatively, a developer can produce metadata for storage in the data store 122 that increases the chances that the BOT will be selected by the RBSC 132.

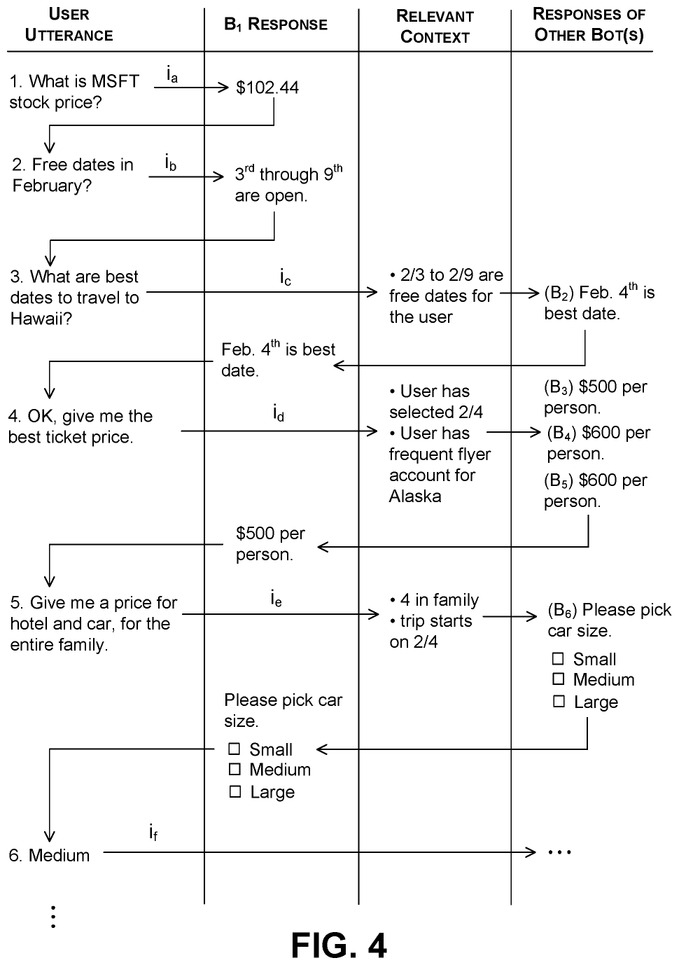

FIG. 4 shows an example of the use of the master BOT framework 104 shown in FIG. 1, with respect to the master-slave topology 202 of FIG. 2. That is, per the topology 202 of FIG. 2, assume that the current (master) BOT 106 serves as the persistent conversational interface through which the user interacts with the current BOT, as well as any subsidiary BOTs invoked by the master BOT framework 104. FIG. 4 designates the current BOT as BOT Bi, which here corresponds to a multi-purpose virtual assistant. The virtual assistant handles many kind of intents, but not all intents.

In a first utterance, the user submits a question, “What is the MSFT stock price?” The current BOT (B₁) 106 includes its own internal intent-monitoring component that determines that this utterance expresses an intent (iₐ) that it can successfully handle. The intent here correspond to a request to obtain a stock price. Assume that, in parallel, the intent-monitoring component 124 of the master BOT framework 104 also assesses the current intent of the current utterance. The current BOT 106 responds to the user's utterance by quoting the price ($102.44) of the specified stock (“MSFT”).

In a second utterance, the user switches to a new task (and associated intent) by asking, “Free dates in February?” Here, the utterance evinces the user's intent (i_{b}) to discover those dates in February for which he has no scheduled obligations. Again assume that the current BOT (B₁) can successfully handle intent. It does so by serving the response, “3^{rd} through 9^{th} are open.”

In a third utterance, the user next asks, “What are the best dates to travel to Hawaii?” At this juncture, the current BOT (B₁) 106 determines that the user is making a request pertaining to travel, associated with intent i_{c}. Assume that, in this merely illustrative case, that the current BOT 106 determines that it cannot handle this utterance. For example, the internal intent-determining component of the current BOT 106 can assign a low score to the current utterance, which indicates that it has low confidence that it understands the nature of this request. The routing component 130 determines that it is appropriate to select a new BOT on the basis of this score, and/or based on the independent intent analysis performed by the global intent-monitoring component 124. In this case, the routing component 130 calls on the BOT registry 112 to propose a new BOT that can handle the current intent.

Alternatively, or in addition, the routing component 130 can mine the user's utterance to determine whether it contains evidence that the user is unhappy with the current BOT 106. For example, although not shown, assume that the current BOT 106 responds to the user's utterance (“What are the best dates to travel to Hawaii”) with the expression, “Hawaii became a state in 1959.” The user might reply, “No!, Tell me a good date to fly to Hawaii.” The feedback-monitoring component 128 can detect the user's dissatisfaction with the current BOT 106 (e.g., using a sentiment-monitoring component), which may trigger the routing component 130 to query the BOT registry 112 for a replacement BOT. The current BOT 106 can also explicitly ask the user whether he wishes to switch to a new BOT, e.g., by responding: “You appear to be unhappy with the current BOT. Would you like to try a travel-related BOT, TravelMaker, from XYZ Co.?”

Assume that the RBSC 132 identifies a BOT B₂ as a good BOT to handle the user's current utterance. In response, the routing component 130 invokes this BOT B₂. Further note that the routing component 130 passes current context information to the new BOT B₂, which is gleaned from the previous turns of the conversation. That is, the current context information indicates that that, in the prior turn, the current BOT 106 notified the user that the free dates in the user's calendar spanned from February 3^{rd} through the 9^{th}. The current state information expresses at least this information, as it is a relevant to the task of answering the user's current utterance (“What are the best dates to travel to Hawaii?”).

Assume that the invoked BOT B₂ receives both the current utterance (“What are best dates to travel to Hawaii?”) and the current context information. In one implementation, the routing component 130 specifically formulates the current context information as an embellishment or annotation of the current utterance, as if the user directly conveyed this information as part of the current utterance. The BOT B₂ processes the current utterance and current context information, treating the current context information as if it originated directly from the user.

Assume that the BOT B₂ generates a response “Feb. 4^{th} is the best date.”The routing component 130 receives this response and feeds it to the current BOT 106 (B₁), which, in turn, supplies it to the user. Here, the current BOT 106 is serving as an intermediary or shell role in forwarding messages to and from the subsidiary BOT B₂.

The remainder of the dialogue proceeds in the same manner described above. In the fourth utterance, the user makes the request, “OK, give me the best ticket price.” The user is now asking for information regarding the cheapest airline ticket to Hawaii. Again assume that the routing component 130 determines that the current BOT (B₁) 106 cannot handle the current intent (i_{d}). Assume that the second BOT B₂ likewise is ill-equipped to handle the current utterance. In response, the routing component 130 queries the RBSC 132 to find one or more BOTs that can handle the user's request. Assume that the RBSC 132 identifies three such BOTs (B₃, B₄, and B₅). In this example, instead of selecting just the best BOT among this set, the routing component 130 passes the current utterance and accompanying state information to all three BOTs. In this case, the current state information indicates that, in the previous turn, the user has selected February 4^{th} as the departure date of the planned trip. Assume that the current state information also reveals that the user has a frequent flier account with a particular airline. The context-monitoring component 126 can make this determination based on access to one or more sources of knowledge, such as user preference information maintained by a data store.

Assume that all three BOTs (B₃, B₄, and B₅) provide responses. The routing component 130 can choose the response that provides the cheapest ticket price. The routing component 130 then forwards the selected response (“$500 per person”) to the user via the current BOT 106. Alternatively, although not shown, the routing component 130 can forward all three responses to the user, informing the user that these three responses originate from three respective agents.

In the fifth utterance, the user asks, “Give me a price for hotel and car, for the entire family.” This utterance indicates that the user has moved on to a different phase of his transaction, in which he wishes to explore the cost of a hotel and rental car for the trip he is planning. Upon determining that the current BOT (B₁) cannot handle this intent (iₑ), the routing component, in conjunction with the RBSC 132 selects yet another new BOT (B₆). It passes the current utterance together with the current state information to the new BOT (B₆). The current state information indicates that the user's trip starts on February 4th. If authorized by the user, the context-monitoring component 126 also retrieves information from a data store that contains profile information regarding the user, which indicates that there are four people in the user's family. The new BOT (B₆) responds by asking the user what size of rental car he prefers. The routing component 130 again forwards this response to the user via the conversational interface of the current BOT (B₁) 106.

Assume that the BOT B₆'s response is formulated as a menu of options. In the sixth utterance, the user responds by picking one of these options. The multi-BOT transaction shown in FIG. 4 can continue in the above-described manner any number of turns, encompassing any number of intents.

In the example shown in FIG. 4, the context-monitoring component 126 draws primarily from previous turns in the current transaction that the user is currently performing. But the context-monitoring component 126 can be extended to draw from one or more prior transactions. The context-monitoring component 126 can determine that these prior transaction(s) are relevant to the current context based on an assessment that these previous transactions pertain to similar subject matter as the present transaction. Alternatively, or in addition, the context-monitoring component 126 can draw from prior transactions based on the user's explicit reference to these transactions in the current transactions, as when the user says, “Repeat the name of the hotel in Maui that you identified yesterday.”

Note that, in the example of FIG. 4 (which uses the master-slave topology of FIG. 2), the user begins his conversation with the current (master) BOT 104 by default. As mentioned above, this current BOT 106 can correspond to a multi-purpose virtual assistant. In the case of the peer-to-peer topology 302 of FIG. 3, the computing environment 102 can use different strategies to choose the initial BOT with which the user begins the transaction. In a first implementation, the user manually selects the initial BOT. In a second implementation, the master BOT framework 104 automatically chooses a general-purpose BOT as the initial BOT, such as a multi-purpose virtual assistant. In a third implementation, the master BOT framework 104 intercepts the user's initial utterance and determines its intent. It then automatically chooses an initial BOT that is best suited to address this utterance.

As a general characteristic, note that the master BOT framework 104 expedites the user's transaction in at least two regards. First, the master BOT framework 104 automatically invokes new BOTs in the course of an evolving transaction, without requiring the user to search for and manually invoke these BOTs, and without requiring the user to explicitly identify the names of these BOTs in his messages. Indeed, the user may be unaware of the existence of the BOTs that are invoked. Second, the master BOT framework 104 automatically passes relevant context information to each newly invoked BOT, without requiring the user to manually supply this information to the new BOT. These technical features also accommodate the efficient use of computing resources. That is, by reducing an average number of turns in dialogues, the master BOT framework 104 can reduce the utilization of processor, memory, and communication resources that go into implementing those turns.

### A.2. The Routing Component

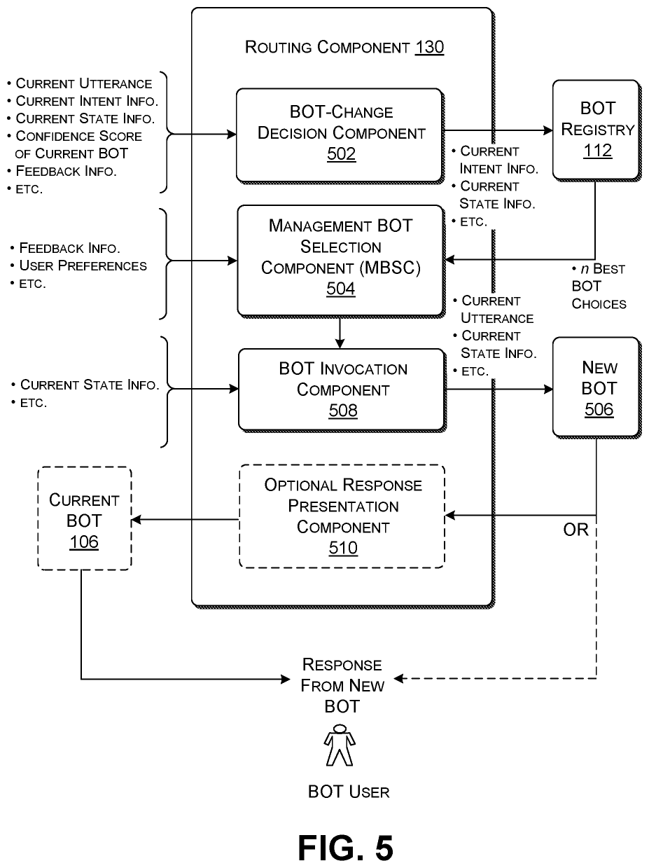

FIG. 5 shows one implementation of the routing component 130. As described above, the routing component 130 orchestrates the transition between BOTs in a multi-BOT transaction. More specifically, the master BOT framework 104 is configured such that any user input utterance sent to a BOT associated with the BOT registry 112 is forwarded to the routing component 130 for analysis and logging. The master BOT framework 104 performs analysis on the input utterance in parallel with the processing performed by the BOT to which the input utterance is directed. Likewise, the master BOT framework 104 is configured such that any response sent by a BOT associated with the BOT registry 112 is forwarded to the routing component 130 for analysis and logging. As described in Subsection A.1, the master BOT framework 104 plays a role in conditioning the input information fed to any BOT and controlling the transition between BOTs. In one implementation, however, each individual BOT otherwise continues to operate in an autonomous manner. From the “perspective” of any individual BOT, it is receiving input utterances and commands directly from a user.

A BOT-change decision component 502 (“decision component” for brevity) determines whether it is appropriate to transition from the current BOT 106 to a new BOT. To make this decision, the decision component 502 can receive input signals from various sources, including, but not limited to: the current utterance from the current BOT 106; current intent information provided by the intent-monitoring component 124; the current state information provided by context-monitoring component 126; the feedback information provided by the feedback-monitoring component 128; and/or a confidence score provided by the current BOT 106. The confidence score reflects a level of confidence, as assessed by the current BOT 106, that it is capable of handling the intent associated with the current utterance.

The decision component 502 can map any combination of the above-described input information items into an output decision, which indicates whether it is appropriate to transition to a new BOT. In one implementation, the decision component 502 can make this decision using any type of machine-trained classification model, examples of which are described below. The machine-trained classification model maps an input vector that represents features in the input information into an output result which indicates whether or not it is appropriate to find a new BOT. Alternatively, or in addition, the decision component 502 can make its decision based on one or more discrete rules. For instance, the decision component 502 can determine that it is appropriate to transition to a new BOT if: (a) the confidence score of the current BOT 106 is below a prescribed environment-specific threshold value; or the current intent (as assessed by the intent-monitoring component 124) is not among the intents that the current BOT 106 is designed to handle (which is information that is conveyed by the BOT metadata in the data store 122); or a sentiment score (as assessed by the feedback-monitoring component 128) is below a prescribed environment-specific threshold value, and so on.

Upon determining that is appropriate to find a new BOT, the decision component 502 sends one or more information items to the RBSC 132 of the BOT registry 112. Those information items can include any of: the current utterance; the current intent information; and the current state information. Based on this input information, assume that the RBSC 132 identifies a set of n new BOTs, each of which is capable of handling the current utterance.

A management BOT selection component (MBSC) 504 selects one or more of the new BOTs in the set based on various environment-specific considerations. For instance, the MBSC 504 can select the new BOT in the set that has the highest matching score. The MBSC 504 can also take previously-specified user preference information into account in making this decision. For instance, assume that the set includes three BOTs that perform the same function. The MBSC 504 may then choose the BOT among this set that has the highest average user rating. Assume that the MBSC 504 chooses the new BOT 506. The MBSC 504 can assign a particular high weight to a BOT that the user himself has previously given a high rating.

A BOT invocation component 508 invokes the new BOT 506. It performs this task by passing the current utterance to the new BOT 506, along with current state information. The BOT invocation component 508 formulates the current state information as if it was directly provided by the current user. The BOT invocation component 508 can perform this task in different ways, such as by using a lookup table to map a parameterized representation of the current state information to a user expression, and then concatenating the user expression with the current utterance. The new BOT 506 then generates a response to this input information based on its BOT-specific internal logic.

The BOT's response may reach the user via at least two paths. In a first path associated with the master-slave topology 202 of FIG. 2, a response presentation component 510 intercepts the response and feeds it to the current (master) BOT 106. The current BOT 106 then presents the response to the user. In a second path associated with the peer-to-peer topology 302 of FIG. 3, the new BOT 506 directly sends the BOT response to the user. Even in this peer-to-peer case, however, the routing component 130 can log the BOT response. The master BOT framework 104 can leverage the BOT response for various purposes, such as to update the current state information. In either path, the new BOT's response can be conceptualized as originating from the master BOT framework 104 because the new BOT 506 operates as a contributing member of the master BOT framework 104.

Assume that the user expresses dissatisfaction with the response issued by the new BOT 506. Upon detecting this sentiment (by the decision component 502), the MBSC 504 can invite the user to select the next-best BOT in the set of BOTs previously identified by the BOT registry 112. Or the decision component 502 can query the BOT registry 112 to find a new set of n BOTs.

### A.3. The BOT Registry

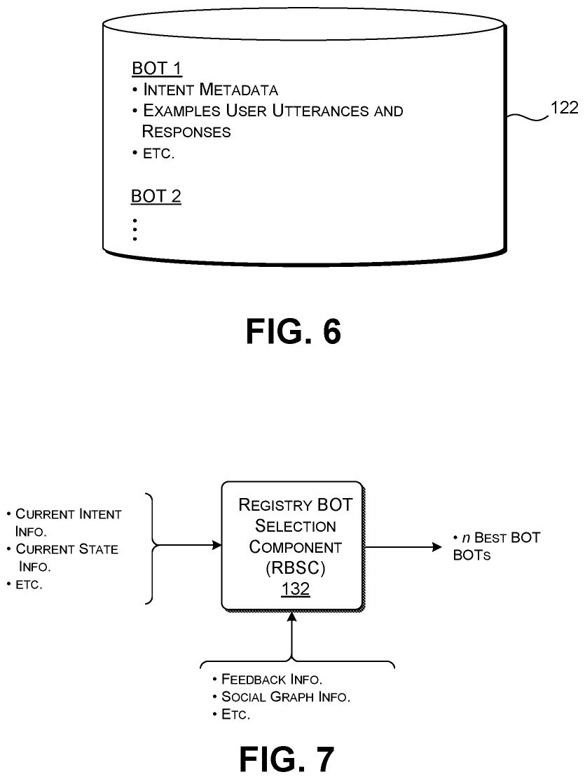

FIG. 6 shows the data store 122 provided in the BOT registry 112 for storing various items of BOT-related information regarding the collection of BOTs 114 associated with the BOT registry 112. For instance, the data store 122 provides intent metadata that describes the intent(s) handled by each BOT. The data store 122 can express each intent in different ways, such as by descriptive keywords, a vector in a semantic space, etc. For example, a developer can use a Deep Neural Network (DNN) to map the utterances that a BOT typically handles into vectors in a semantic space. The vectors may reveal clusters associated with respective intents that the BOT is designed to handle. The developer can represent each intent as a representative reference vector associated with each cluster.

In addition, the data store 122 can provide example utterances that each BOT is configured to handle, as well as example responses associated with those utterances. As noted above, the training system 138 can leverage these example utterances and responses to train one or more models used by the master BOT framework 104. In one implementation, the developer can provide these example utterances and example responses. In addition, or alternatively, the BOT registry 112 itself supplies these examples by feeding sample utterances to each BOT, and recording the responses provided by each such BOT. In addition, or alternatively, the BOT registry 112 can mine these examples from the data store 134, which stores actual utterances made by users in the course of interacting with these BOTs, together with actual responses provided by the BOTs. In addition, or alternatively, the BOT registry 112 can mine these examples from recorded conversations between people, e.g., between users and human service representatives.

FIG. 7 shows one implementation of the registry BOT selection component (RBSC) 132, which is another element of the BOT registry 112. In operation, the RBSC 132 receives various items of input information from the routing component 130, and, based thereon, chooses a set of one or more new BOTs (if any) that are appropriate to handle a current utterance. Without limitation, the input information can include: the current utterance; the current intent information; and the current state information.

In one implementation, the RBSC 132 uses a machine-trained classification component to map the input information into an indication of the BOT(s) that can handle the current utterance. For example, the RBSC 132 can use a DNN to map an input vector that represents features in the input information into a current intent vector in a semantic space. The RBSC 132 can then determine the distance between this current intent vector and each reference vector associated with each candidate BOT (which is information that may be computed in advance and stored in the data store 122). The RBSC 132 can compute this distance using any metric, such as cosine similarity. The RBSC 132 can then select the n BOTs having reference vectors that are closest to the current intent vector.

Alternatively, or in addition, the RBSC 132 can select the n most suitable BOTs based by matching a keyword associated with the current intent (as assessed by the intent-monitoring component 124) with intent-related keywords associated with the BOTs 114 in the registry (which is information stored in the data store 122).

Alternatively, or in addition, the RBSC 132 can take feedback information into account in selecting the n most suitable BOTs. For example, the RBSC 132 can modify the score of each candidate BOT by an average rating given to this BOT by a group of users. Alternatively, or addition, the RBSC 132 can boost (or devalue) the score of a candidate BOT based on preference information expressed by the current user, and/or by other people who have some relation to the current user. The RBSC 132 can perform this latter task by using a social graph to identify the set of people who have a known relation to the current user, and then extracting the preference information associated with those people, if so authorized by those people.

### A.4. The Intent, Context, and Feedback Monitoring Components

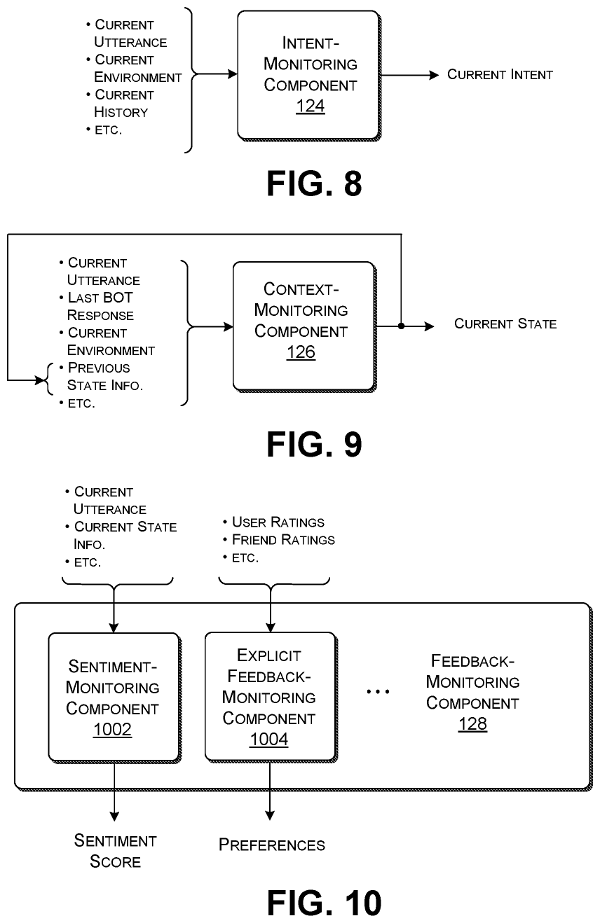

FIG. 8 shows one implementation of the intent-monitoring component 124. This component determines the intent of the current utterance based on various items of input information, including, but not limited to: the current utterance; the current environment; the user's current history, etc.

In one implementation, the intent-monitoring component 124 performs its task using a machine-trained model. For instance, a DNN can map an input vector that represents features in the input information into a score which reflects the intent of current utterance. In another implementation, the intent-monitoring component 124 maps keywords in the current utterance into an indication of the utterance's intent. For example, the keywords “find” and “movie” indicate that the user is interested in finding a particular movie, while the keywords “buy” and “movie” indicate that the user is interested in purchasing a particular movie, etc.

FIG. 9 shows one implementation of the context-monitoring component 126. This component determines the current state of the conversation. As previously noted, a description of the current state may encompass information that the user or any BOT may have provided in previous turns of the conversion, and/or in one or more previous conversations. Generally, the context-monitoring component 126 performs its task by mapping input information into current state information. Without limitation, the input information can include: the current utterance; the last BOT response; information regarding the current environment (such as the time, place, etc.); user profile information; user preference information; information regarding previous states, etc. In one implementation, the context-monitoring component 126 can represent a current state as a set of slot-value pairs which convey the task that the user is attempting to convey, together with the user's progress in completing the task. For instance, with respect to the task of reserving a table at a restaurant, the current state may specify the pairs: “Restaurant <Olive Garden>, Attendees <2>, Time <unknown>.” This information conveys that the user has currently supplied all the information necessary to reserve the table, except for specifying the time of the reservation.

In one implementation, the context-monitoring component 126 performs its task using a discriminative machine-trained model. For instance, the context-monitoring component 236 can use a machine-trained classification component to map an input vector that represents features in the input information into an output result which is indicative of the current state. In so doing, the context-monitoring component 126 can take into consideration state information for the last k turns of the dialogue. Or the context-monitoring component 126 can use a sequence-based machine-trained model to dynamically compute the current state information, e.g., by using a Conditional Random Field (CRF) model, a Recurrent Neural Network (RNN) model, etc. In another implementation, the context-monitoring component 126 performs its task using a machine-trained generative model. In another implementation, the context-monitoring component 126 can perform its task using a series of discrete rules. For example, the context-monitoring component 126 can assess the state by identifying a form associated with the task that the user is attempting to perform, and then identifying the slots of the form for which values have been provided, and those which still lack values.

In addition, or alternatively, the context-monitoring component 126 can also using various machine-trained and/or rules-based tools to assess the current state, including, but not limited to: entity extraction tools (which determine the presence of named entities in the user's utterances); relation extraction tools (which determine the presence of relations expressed in the user's utterances); pronoun resolution tools (which identify the persons or things referred to by pronouns in the user's utterances); goal-assessment tools (which identify the goal(s) that the user is attempting to achieve), and so on.

FIG. 10 shows one implementation of the feedback-monitoring component 128. The feedback-monitoring component 128 collects evidence regarding the user's assessment of an ongoing conversation, and analyzes it. The feedback-monitoring component 128 can include a set of submodules to perform its task, including a sentiment-monitoring component 1002, an explicit feedback-monitoring component 1004, etc. The sentiment-monitoring component 1002 maps various items of input information (such as the current utterance, the current state information, etc.) into an output result which reflects the user's current sentiment. The sentiment-monitoring component 1002 can perform this task using a machine-trained classification component which maps an input vector that represents features in the input information into an output result. Alternatively, the sentiment-monitoring component 1002 can use keywords in the user's input utterance to gauge the user's assessment of the ongoing dialogue. For example, the sentiment-monitoring component 1002 can apply a rule which maps the phrase “That's not what I meant,” into an indication that the user is unhappy with the current BOT with which he is interacting.

The explicit feedback-monitoring component 1004 collects the user's explicit feedback, such as the user's explicit rating of a BOT as expressed in the user's utterances. In some cases, the user may supply this information without being prompted to do so. For example, the user can state, “Thanks for your help. I give you five stars!” In other cases, the explicit feedback-monitoring component 1004 can solicit this information, e.g., by providing the response, “Please let me know what you think of my service on a scale of 1 to 5, 5 being the best.”

The explicit feedback-monitoring component 1004 can also identify the explicit or implicit ratings of other people who have a known relationship with the current user. The explicit feedback-monitoring component 1004 can make this determination based on social graph information, together with stored preference information associated with people identified in the social graph information. In some implementations, the explicit feedback-monitoring component 1004 searches a user's social graph for this kind of preference information. In other cases, a user's social contact can explicitly supply this preference information, as when a friend issues the following command in a previous conversation: “Tell @robin to try out TableSetter.” In response to this person's preference information, in whatever manner obtained, the explicit feedback-monitoring component 1004 can automatically apply it to the selection of a new BOT, without asking the user. Or the explicit feedback-monitoring component 1004 can explicitly ask the user whether he or she wishes to invoke a BOT recommended by another person, e.g., by outputting the response: “You appear to be interested in making a restaurant reservation. Your friend Jim recommends TableSetter produced by XYZ Co. to perform this task. Do you want to invoke it?”

### A.5. A Representative BOT

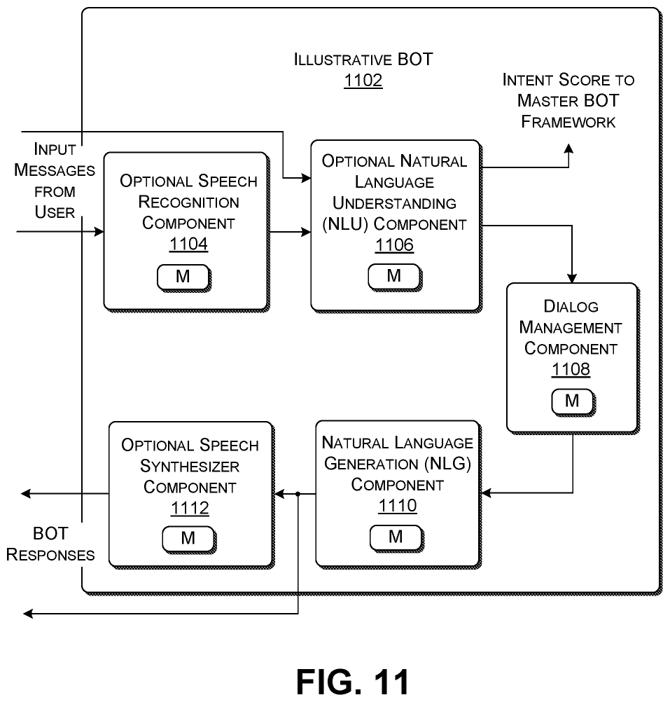

FIG. 11 shows a representative BOT 1102 that a user may interact with in conjunction with the services of the master BOT framework 104. The details of this BOT 1102 are set forth in the spirit of illustration, not limitation. Indeed, the master BOT framework 104 is designed to be agnostic with respect to the logic used by the BOTs 114 in the BOT registry 112; the master BOT framework 104 can therefore be used in conjunction with BOTs having any architecture and logic.

An optional speech recognition component 1104 converts a stream of audio signals received from a microphone into text information. The audio signals convey the user's natural language input expression. The speech recognition component 1104 can perform this task using any speech recognizer technology, such as a Recurrent Neural Network (RNN) composed of Long Short-Term Memory (LSTM) units, a Hidden Markov Model (HMM), etc. (Note that the symbol “M” in FIG. 11 generally indicates the use of some machine-trained model, rules-based engine, etc., or any combination thereof.) The speech recognition component 1104 is labeled as optional because, in another mode of input, the user may provide an input expression to the BOT 1102 in text form via a keyboard input device or the like.

A natural language understanding (NLU) component 1106 interprets the linguistic information provided by the speech recognition component 1104 (or as directly input by the user), to provide an interpreted input expression. Different NLU components 1106 use different analysis techniques. In one merely illustrative case, the NLU component 1106 can use an optional domain determination component (not shown) to first determine the most probable domain associated with an input expression. A domain pertains to the general theme to which an input expression pertains. For example, the command “find Mission Impossible” pertains to a media search domain. An intent determination component (not shown) next determines an intent associated with the input expression. An intent corresponds to an objective that a user likely wishes to accomplish by submitting an input expression. For example, a user who submits the input expression “find Mission Impossible” intends to find a particular movie having the name of “Mission Impossible.” A user who submits the command “buy Mission Impossible” intends to purchase this movie, and so on. A slot value determination component (not shown) then determines slot values in the input expression. The slot values correspond to information items that a skill component or application needs to perform a requested task, upon interpretation of the input expression. For example, the command, “find Jack Nicolson movies in the comedy genre” includes a slot value “Jack Nicolson” that identifies an actor having the name of “Jack Nicolson,” and a slot value “comedy” corresponding to a requested genre of movies.

In one case, the NLU component 1106 can implement its various subcomponents using one or more machine-trained models. For example, the domain determination component can use any machine-trained classification model. The intent determination component can likewise use any machine-trained classification model. The slot value determination component can use a Conditional Random Field (CRF) model, etc. Alternatively, or in addition, the NLU component 1106 can implement any of its subcomponents using one or more rules-based engines. For example, the intent determination component can apply a rule which posits that any input expression which contains the keyword “buy” pertains to a purchase-related intent.

A dialogue management component 1108 performs two tasks. It first assesses the current state of the dialogue. It then maps the current state into an output response. The dialogue management component 1108 can perform the state-determination task using any of the techniques described above with respect to FIG. 9, but here applied in a localized BOT-specific context. The dialogue management component 1108 can perform its second task using a machine-trained discriminative or generative model. For instance, a machine-trained generative model can map the user's current utterance and the current state information (as locally assessed by the BOT 1102) into the BOT's response. In another implementation, the dialogue management component 1108 generates a response based on one or more discrete rules, and/or based on one or more pre-stored scripts.

Some dialogue management components can also make use of a set of skills components, each of which handles a prescribed task. In this case, the dialogue management component 1108 can pass the user's utterance and the associated state information to an appropriate skill component, e.g., based on the intent information assessed by the NLU component 1106. Further note that, in some cases, the dialogue management component 1108 can consult one or more external knowledge bases in generating its response. This is particularly true for BOTs that perform an information retrieval function.

A natural language generation (NLG) component 1110 maps each answer given by the dialogue management component 1108 into an output expression in a natural language, to provide the final system response given to the user. More specifically, the dialogue management component 1108 may output its answer in parametric form. For instance, in the context of making a flight reservation, a skill component can provide an answer that specifies a flight number, a flight time, a flight status, and a message type. The message type identifies purpose of the message; here, the purpose of the message is to convey the flight status of a flight. The NLG component 1110 converts this answer into a natural language expression, constituting the BOT response that is provided to the user. It can do this using a lookup table, one or more machine-trained models, one or more rules-based engines, and so on. Finally, an optional speech synthesizer component 1112 converts a text-based BOT response into a spoken system prompt, if the user is set up to receive a spoken response.

Generally note that the representative BOT 1102 natively supports some of the same functions performed by the master BOT framework 104. For instance, both the representative BOT 1102 and the master BOT framework 104 perform intent and state analysis. But the master BOT framework 104 performs its function on a global level, potentially with respect to a multi-BOT transaction. Each individual BOT, in contrast, performs these functions with respect it its own role in the multi-BOT transaction.

Further note that the master BOT framework 104 can rely on the localized analysis performed by each BOT. For example, assume that the NLU component 1106 of the BOT 1102 assesses the intent of an input utterance with low confidence. The routing component 130 can use this signal as one of its triggers to find a new BOT to handle the user's utterance.

### A.6. Examples of Machine-Trained Components

As noted in the previous subsections, the master BOT framework 104 can optionally rely on various machine-trained models to perform its tasks. These models can include various kinds of discriminative models or generative models. More specifically, the machine-trained models can include, but not are not limited to: logistic regression models; neural network models; clustering-based models; decision tree models; Support Vector Machine (SVM) models; Bayesian models, and so on. The neural network models can include various kinds of Deep Neural Networks (DNNs). Without limitation, this subsection describes two representative types of machine-trained models.

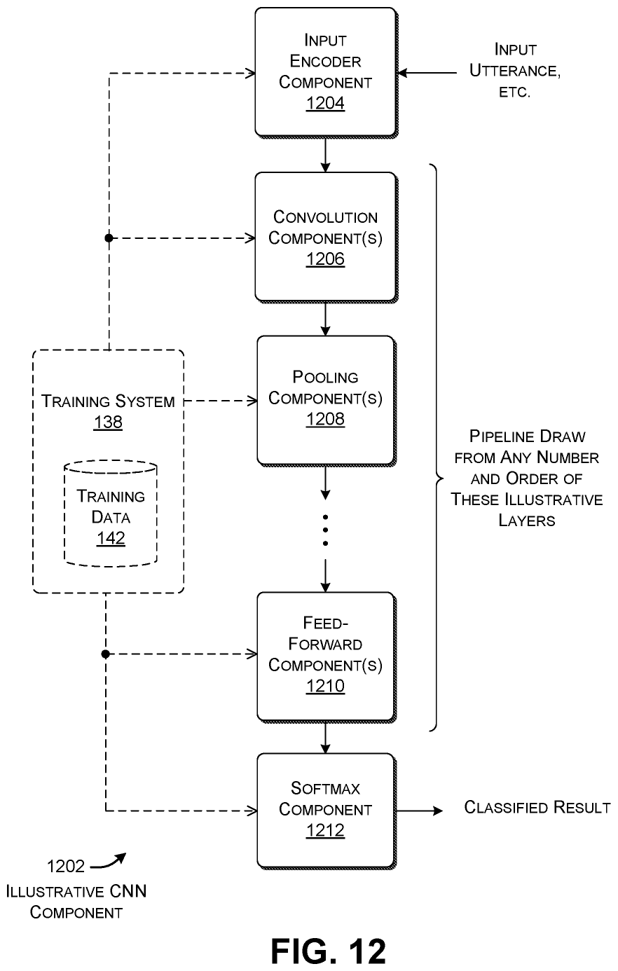

More specifically, FIG. 12 show a representative Convolutional Neural Network (CNN) component 1202, which constitutes a certain kind of DNN. The CNN component 1202 will be explained below in the concrete case of the sentiment-monitoring component 1102, but a similar DNN can be used in other parts of the master BOT framework 104. For example, the routing component 130 can use a DNN component to map input information into an indication of whether it is appropriate to select a new BOT. The intent-monitoring component 124 can use a DNN component to map input information into an indication of the user's current intent. And the RBSC 132 can use a DNN component to map input information into one or more identifiers associated with BOTs, etc.

The CNN component 1202 performs analysis in a pipeline of stages. An input encoder component 1204 first transforms each input token of the user's current utterance into an appropriate form for further processing by the CNN component 1202. For example, in one merely illustrative case, the input encoder component 1204 can transform each word into a vector which describes the trigrams that are present in the word. A trigram, in turn, includes each three-character sequence in the word. For example, the input encoder component 1204 can map the word “sunset” into a vector having a 1 entry for each of the trigrams “sun,” “uns,” “nse,” and “set,” and a 0 entry for other trigram dimensions. The input encoder component 1204 can map other items of input information into vector form using a lookup table or some other mapping function.

The CNN component 1202 can process the input vectors provided by the input encoder component 1204 in successive layers associated with one or more convolution components 1206, one or more pooling components 1208, one or more feed-forward components 1210, a softmax component 1212, and so on. That is, an environment-specific implementation of the CNN component 1202 can include any number of these different layers, and can interleave these layers in any manner.

A convolution component can move an n-word window across the sequence of input word vectors. In doing so, it forms a series of vectors, each of which combines together the n words encompassed by the window at a given position. For example, if the input utterance reads, “That is not what I want,” then the convolution component can form three-word vectors associated with “<s>That is,” “That is not,” “not what I,” and so on (where the token “<s>” denotes the start of the sentence). More specifically, the convolution component can form the three-word vectors by concatenating the three trigram word vectors encompassed by the window. The convolution component can then transform the resultant three-word vector (gₜ) in any manner, e.g., by producing a hidden state vector hₜ=tan h(W_{c}gₜ), where W_{c}, is a machine-learned weighting matrix.

A pooling component can reduce the dimensionality of a previous layer using any type of down-sampling strategy. For example, a max-pooling component can select a maximum value across each dimension of the hidden state vectors fed to it by a preceding convolution component, to form a global feature vector v. For instance, to provide a value at index i of the global feature vector v, the pooling component can select the maximum value across the input hidden state vectors at the same index i. In other words,

$$v ( i ) = {max}_{t = 1 , … , T} \{ {h}_{t} ( i ) \} , i = 1 , … T . \qquad ( 1 )$$

Here, i refers to a particular element of the global feature vector v , and, correspondingly, in each of the input hidden state vectors, hₜ. T is the total number of elements in the global feature vector.

A feed-forward component processes an input vector using a feed-forward neural network. In a single-layer case, an illustrative feed-forward component projects the global feature vector v into a continuous-valued concept vector y using a machine-learned semantic projection matrix Wₛ. That is, y=tan h(Wₛv). Here, the concept vector y specifies a sentiment associated with the input utterance, such as satisfaction, anger, confusion, etc. (More generally, the values in any layer j of a feed-forward network may be given by the formula, zⱼ=f(Wⱼzⱼ₋₁+bⱼ), for j=2, . . . N. The symbol Wⱼ denotes a j-th machine-learned weight matrix, and the symbol bⱼ refers to an optional j-th machine-learned bias vector. The activation function f(x) can be formulated in different ways, such as the tan h function.)

The optional softmax component 1212 operates on the output of the preceding layers using a normalized exponential function, to generate final output information. That output information reflects the sentiment expressed by the user's utterance.

The training system 138 iteratively produces values that govern the operation of at least the convolution component(s) 1206 and the feed-forward component(s) 1210, and optionally the pooling component(s) 1208. These values collectively constitute a machine-trained model. The training system 138 can perform its learning by iteratively operating on a set of training examples in the data store 142, e.g., using gradient descent or some other machine-training technique.

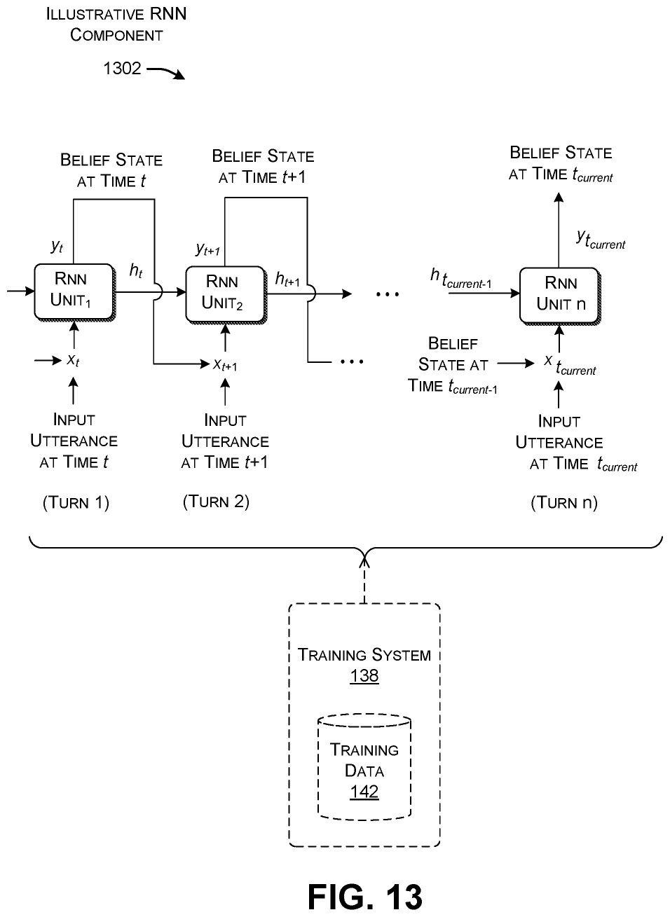

Advancing to FIG. 13, this figure shows an illustrative Recurrent Neural Network (RNN) component 1302. The RNN component 1302 is explained below in the context of the implementation of the context-monitoring component 126. But other parts of the master BOT framework 104 can use this kind of model to perform their respective functions.

The RNN component 1302 can include one or more layers of RNN units, only one layer of which is shown in FIG. 13. Each layer of the RNN component, in turn, includes a series of RNN units, shown in “unrolled” form in FIG. 13 for purposes of explanation. The RNN units can be implemented in various ways, such as using Long Short-Term Memory (LSTM) memory units, Gated Recurrent Units (GRUs), etc. (In actuality, an RNN component implements each RNN layer using a single body of code; the unrolled form shown in FIG. 13 represents the operation of that single body of code at different instances of time t, with respect to different input values xₜ.)

In a feed-forward RNN component, each RNN unit accepts a first input corresponding to a hidden state vector hₜ₋₁ from a preceding RNN unit (if any), and a second input corresponding to an input vector xₜ for time instance t. The RNN units perform cell-specific processing on these input vectors to generate a new hidden state vector hₜ and an output vector yₜ. In one merely illustrative case, the RNN units compute hₜ and yₜ using the following equations:

hₜ=σ(Wₓₕxₜ+Wₕₕhₜ₋₁+bₕ) (2),

yₜ=σ(W_{hy}hₜ+b_{y}) (3).

The symbol a represents a logistic sigmoid function. The various weighting terms (W) and bias terms (b) represent machine-learned parameter values. In other cases, each layer of the RNN units can also, or alternatively, feed hidden state information in the “backward” (right-to-left) direction.

When employed by the context-monitoring component 126, each output vector yₜ of an RNN unit represents the current state (also referred to as the belief state) of the dialogue at time t, which is associated with a particular turn of the dialogue. The input vector xₜ of the RNN unit corresponds to a vector that represents the current utterance at time t, concatenated with the current state yₜ₋₁ identified by the preceding RNN unit. The last RNN unit generates an output vector which reflects the current state yₜ_{_{current}} of the dialogue at the present time t_{current}.

The training system 138 iteratively produces values that govern the operation of at least the RNN units. These values collectively constitute a machine-trained model. The training system 138 can perform its learning by iteratively operating on a set of training examples in the data store 142, e.g., using gradient descent or some other machine-trained technique.

### B. Illustrative Processes

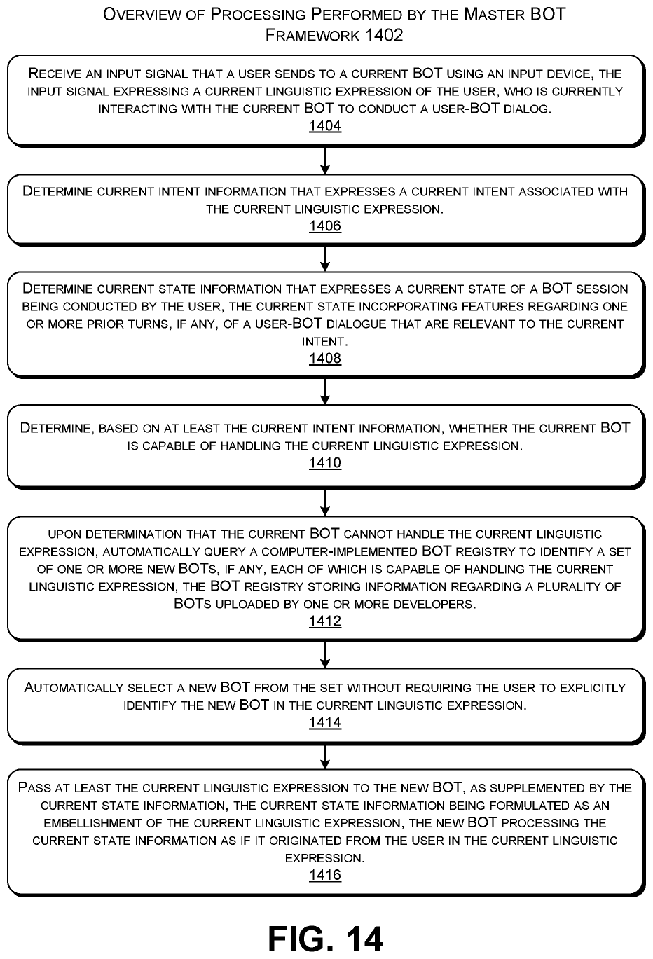

FIGS. 14-16 show processes that explain the operation of the master BOT framework 104 of Section A in flowchart form. Since the principles underlying the operation of the master BOT framework 104 have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

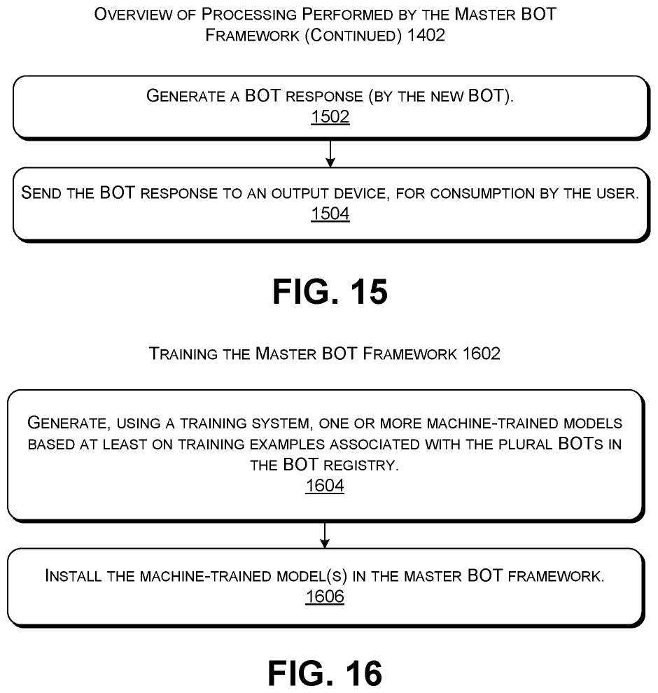

FIGS. 14 and 15 together shows a process 1402 that explains one manner of operation of the master BOT framework 104 of FIG. 1. In block 1404, the master BOT framework 104 receives an input signal that a user sends to a current BOT 106 using an input device, the input signal expressing a current linguistic expression of the user, who is currently interacting with the current BOT 106 to conduct a user-BOT dialogue. In block 1406, the master BOT framework 104 determines current intent information that expresses a current intent associated with the current linguistic expression. In block 1408, the master BOT framework 104 determines current state information that expresses a current state of a BOT session being conducted by the user, the current state incorporating features regarding one or more prior turns, if any, of a user-BOT dialogue that are relevant to the current intent. In block 1410, the master BOT framework 104 determines, based on at least the current intent information, whether the current BOT 106 is capable of handling the current linguistic expression. In block 1412, upon determination that the current BOT 106 cannot handle the current linguistic expression, the master BOT framework automatically queries a computer-implemented BOT registry 112 to identify a set of one or more new BOTs, if any, each of which is capable of handling the current linguistic expression, the BOT registry 112 storing information regarding a plurality of BOTs uploaded by one or more developers. In block 1414, the master BOT framework 104 automatically selects a new BOT 506 from the set without requiring the user to explicitly identify the new BOT in the current linguistic expression. In block 1416, the master BOT framework 104 passes at least the current linguistic expression to the new BOT 506, as supplemented by the current state information, the current state information being formulated as an embellishment of the current linguistic expression. The new BOT 506 processes the current state information as if it originated from the user in the current linguistic expression. Advancing to FIG. 15, in block 1502, the new BOT 506 generates a BOT response. In block 1504, the new BOT 506 sends the BOT response to an output device, for consumption by the user, either directly or via the routing component 130. The master BOT framework 104 also logs the BOT response.

FIG. 16 shows a process 1602 that represents one illustrative manner of operation of the training system 138 of FIG. 1. In block 1604, the training system 138 generates one or more machine-trained models 140 based at least on training examples (in a data store 142) associated with plural BOTs 114 in the BOT registry 112. In block 1606, the training system 138 installs the machine-trained models 140 in the master BOT framework 104.

### C. Representative Computing Functionality

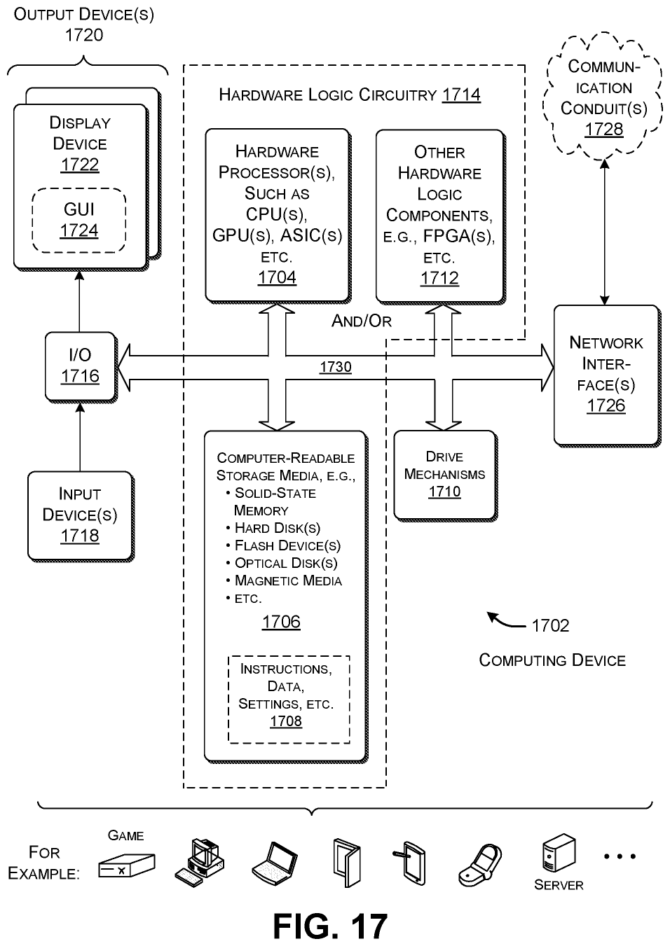

FIG. 17 shows a computing device 1702 that can be used to implement any aspect of the mechanisms set forth in the above-described figures. For instance, with reference to FIG. 3, the type of computing device 1702 shown in FIG. 17 can be used to implement any computing device associated with the master BOT framework 104, the user device 108, the current BOT 106, etc. In all cases, the computing device 1702 represents a physical and tangible processing mechanism.

The computing device 1702 can include one or more hardware processors 1704. The hardware processor(s) can include, without limitation, one or more Central Processing Units (CPUs), and/or one or more Graphics Processing Units (GPUs), and/or one or more Application Specific Integrated Circuits (ASICs), etc. More generally, any hardware processor can correspond to a general-purpose processing unit or an application-specific processor unit.

The computing device 1702 can also include computer-readable storage media 1706, corresponding to one or more computer-readable media hardware units. The computer-readable storage media 1706 retains any kind of information 1708, such as machine-readable instructions, settings, data, etc. Without limitation, for instance, the computer-readable storage media 1706 may include one or more solid-state devices, one or more magnetic hard disks, one or more optical disks, magnetic tape, and so on. Any instance of the computer-readable storage media 1706 can use any technology for storing and retrieving information. Further, any instance of the computer-readable storage media 1706 may represent a fixed or removable component of the computing device 1702. Further, any instance of the computer-readable storage media 1706 may provide volatile or non-volatile retention of information.

The computing device 1702 can utilize any instance of the computer-readable storage media 1706 in different ways. For example, any instance of the computer-readable storage media 1706 may represent a hardware memory unit (such as Random Access Memory (RAM)) for storing transient information during execution of a program by the computing device 1702, and/or a hardware storage unit (such as a hard disk) for retaining/archiving information on a more permanent basis. In the latter case, the computing device 1702 also includes one or more drive mechanisms 1710 (such as a hard drive mechanism) for storing and retrieving information from an instance of the computer-readable storage media 1706.

The computing device 1702 may perform any of the functions described above when the hardware processor(s) 1704 carry out computer-readable instructions stored in any instance of the computer-readable storage media 1706. For instance, the computing device 1702 may carry out computer-readable instructions to perform each block of the processes described in Section B.

Alternatively, or in addition, the computing device 1702 may rely on one or more other hardware logic components 1712 to perform operations using a task-specific collection of logic gates. For instance, the hardware logic component(s) 1712 may include a fixed configuration of hardware logic gates, e.g., that are created and set at the time of manufacture, and thereafter unalterable. Alternatively, or in addition, the other hardware logic component(s) 1712 may include a collection of programmable hardware logic gates that can be set to perform different application-specific tasks. The latter category of devices includes, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 17 generally indicates that hardware logic circuitry 1714 includes any combination of the hardware processor(s) 1704, the computer-readable storage media 1706, and/or the other hardware logic component(s) 1712. That is, the computing device 1702 can employ any combination of the hardware processor(s) 1704 that execute machine-readable instructions provided in the computer-readable storage media 1706, and/or one or more other hardware logic component(s) 1712 that perform operations using a fixed and/or programmable collection of hardware logic gates. More generally stated, the hardware logic circuitry 1714 corresponds to one or more hardware logic components of any type(s) that perform operations based on logic stored in and/or otherwise embodied in the hardware logic component(s).

In some cases (e.g., in the case in which the computing device 1702 represents a user computing device), the computing device 1702 also includes an input/output interface 1716 for receiving various inputs (via input devices 1718), and for providing various outputs (via output devices 1720). Illustrative input devices include a keyboard device, a mouse input device, a touchscreen input device, a digitizing pad, one or more static image cameras, one or more video cameras, one or more depth camera systems, one or more microphones, a voice recognition mechanism, any movement detection mechanisms (e.g., accelerometers, gyroscopes, etc.), and so on. One particular output mechanism may include a display device 1722 and an associated graphical user interface presentation (GUI) 1724. The display device 1722 may correspond to a liquid crystal display device, a light-emitting diode display (LED) device, a cathode ray tube device, a projection mechanism, etc. Other output devices include a printer, one or more speakers, a haptic output mechanism, an archival mechanism (for storing output information), and so on. The computing device 1702 can also include one or more network interfaces 1726 for exchanging data with other devices via one or more communication conduits 1728. One or more communication buses 1730 communicatively couple the above-described components together.

The communication conduit(s) 1728 can be implemented in any manner, e.g., by a local area computer network, a wide area computer network (e.g., the Internet), point-to-point connections, etc., or any combination thereof. The communication conduit(s) 1728 can include any combination of hardwired links, wireless links, routers, gateway functionality, name servers, etc., governed by any protocol or combination of protocols.

FIG. 17 shows the computing device 1702 as being composed of a discrete collection of separate units. In some cases, the collection of units may correspond to discrete hardware units provided in a computing device chassis having any form factor. FIG. 17 shows illustrative form factors in its bottom portion. In other cases, the computing device 1702 can include a hardware logic component that integrates the functions of two or more of the units shown in FIG. 1. For instance, the computing device 1702 can include a system on a chip (SoC or SOC), corresponding to an integrated circuit that combines the functions of two or more of the units shown in FIG. 17.

The following summary provides a non-exhaustive set of illustrative aspects of the technology set forth herein.

According to a first aspect, one or more computing devices are described for facilitating interaction with plural computer-implemented BOTs. The computing device(s) include hardware logic circuitry, the hardware logic circuitry corresponding to: (a) one or more hardware processors that perform operations by executing machine-readable instructions stored in a memory, and/or (b) one or more other hardware logic components that perform operations using a task-specific collection of logic gates. The operations include: receiving, by a computer-implemented master BOT framework, an input signal that a user sends to a current BOT using an input device, the input signal expressing a current linguistic expression of the user, who is currently interacting with the current BOT to conduct a user-BOT dialogue; determining, using an intent-monitoring component provided by the master BOT framework, current intent information that expresses a current intent associated with the current linguistic expression; determining, using a context-monitoring component provided by the master BOT framework, current state information that expresses a current state of a BOT session being conducted by the user, the current state incorporating features regarding one or more prior turns, if any, of the user-BOT dialogue that are relevant to the current intent; and determining, using a routing component provided by the master BOT framework, and based on at least the current intent information, whether the current BOT is capable of handling the current linguistic expression. The operations further include, upon determination that the current BOT cannot handle the current linguistic expression, using the routing component to query a computer-implemented BOT registry provided by the master BOT framework to identify a set of one or more new BOTs, if any, each of which is capable of handling the current linguistic expression, the BOT registry storing information regarding a plurality of BOTs uploaded by one or more developers. The operations further include: selecting, using the routing component, a new BOT from the set; and passing, using the routing component, at least the current linguistic expression to the new BOT, as supplemented by the current state information. The routing component is communicatively coupled to the intent-monitoring component, the context-monitoring component, and the BOT registry of the master BOT framework.

According to a second aspect, the new BOT is automatically chosen without requiring the user to explicitly identify the new BOT in the current linguistic expression.

According to a third aspect, the current BOT is integrated with the master BOT framework, and wherein the master BOT framework relies on the current BOT to forward the BOT response, provided by the new BOT, to the user.

According to a fourth aspect, the master BOT framework relies on the new BOT to directly send the BOT response to the user.

According to a fifth aspect, the current state expresses information supplied by the user in one or more linguistic expressions, prior to the current linguistic expression.

According to a sixth aspect, the current state expresses information supplied by one or more BOT responses, prior to the current linguistic expression.

According to a seventh aspect, the master BOT framework uses, at least in part, one or more machine-trained models.

According to an eighth aspect, the BOT registry includes a data store which stores sets of example linguistic expressions for respective BOTs, each set corresponding to linguistic expressions that an associated BOT is configured to handle.

According to a ninth aspect, the processing operations further include generating, using a training system, one or more machine-trained models for use by the master BOT framework, the training system generating the machine-trained model(s) based at least on training examples associated with the plural BOTs, the training examples being provided by the BOT registry.

According to a tenth aspect, the operation of determining whether the current BOT is capable of handling the current linguistic expression is also based on a confidence score provided by the current BOT.

According to an eleventh aspect, the BOT registry includes a first BOT selection component that is configured to select the set of BOTs, each of which is capable of handling the current linguistic expression. Further, the routing component includes a second BOT selection component for performing the selecting of the new BOT from among the set.

According to a twelfth aspect, dependent on the eleventh aspect, the first BOT selection component and/or the second BOT selection component take into consideration a BOT-related preference of another user, the other user having a predetermined relation with the user who provided the current linguistic expression, the relation being defined by a social graph stored in a data store.

According to a thirteenth aspect, at least some of the BOTs in the BOT registry are framework-agnostic BOTs that do not include logic that is specifically designed for interaction with the master BOT framework.

According to a fourteenth aspect, a method is described, implemented by one or more computing devices, for facilitating interaction with plural computer-implemented BOTs. The method includes: receiving, by a computer-implemented master BOT framework, an input signal that a user sends to a current BOT using an input device, the input signal expressing a current linguistic expression of the user, who is currently interacting with the current BOT to perform a user-BOT dialogue; determining, by the master BOT framework, current intent information that expresses a current intent associated with the current linguistic expression; determining, by the master BOT framework, current state information that expresses a current state of a BOT session being conducted by the user, the current state incorporating features regarding one or more prior turns, if any, of the user-BOT dialogue that are relevant to the current intent; and determining, using a routing component provided by the master BOT framework, and based on at least the current intent information, whether the current BOT is capable of handling the current linguistic expression. The method further includes, upon determination that the current BOT cannot handle the current linguistic expression, using the routing component to automatically query a computer-implemented BOT registry provided by the master BOT framework to identify a set of one or more new BOTs, if any, each of which is capable of handling the current linguistic expression, the BOT registry storing information regarding a plurality of BOTs uploaded by one or more developers. The method further includes: automatically selecting, using the routing component, a new BOT from the set without requiring the user to explicitly identify the new BOT in the current linguistic expression; and passing, by the routing component, at least the current linguistic expression to the new BOT, as supplemented by the current state information, the current state information being formulated as an embellishment of the current linguistic expression.

According to a fifteenth aspect, dependent on the fourteenth aspect, the current BOT is integrated with the master BOT framework, and wherein the master BOT framework relies on the current BOT to forward the BOT response, provided by the new BOT, to the user.

According to a sixteenth aspect, dependent on the fourteenth aspect, the master BOT framework relies on the new BOT to directly send the BOT response to the user.

According to a seventeenth aspect, the current state expresses: information supplied by the user in one or more linguistic expressions, prior to the current linguistic expression; and/or information supplied by one or more BOT responses, prior to the current linguistic expression; and/or information associated with the user obtained from one or more data stores.

According to an eighteenth aspect, dependent on the fourteenth aspect, the master BOT framework is implemented, at least in part, using one or more machine-trained models. The method further includes generating, using a training system the machine-trained model(s). The training system generates the machine-trained model(s) based at least on training examples associated with the plural BOTs, the training examples being provided by the BOT registry.

According to a nineteenth aspect, dependent on the fourteenth aspect, at least some of the BOTs in the BOT registry are framework-agnostic BOTs that do not include logic that is specifically designed for interaction with the master BOT framework.

According to a twentieth aspect, a computer-readable storage medium is described for storing computer-readable instructions. The computer-readable instructions, when executed by one or more hardware processors, perform a method that includes: receiving an input signal that a user sends to a current BOT using an input device, the input signal expressing a current linguistic expression of the user, who is currently interacting with the current BOT to conduct a user-BOT dialogue; determining current intent information that expresses a current intent associated with the current linguistic expression; determining current state information that expresses a current state of a BOT session being conducted by the user, the current state incorporating features regarding one or more prior turns, if any, of the user-BOT dialogue that are relevant to the current intent; and determining, based on at least the current intent information, whether the current BOT is capable of handling the current linguistic expression. Upon determination that the current BOT cannot handle the current linguistic expression, the method further includes automatically querying a computer-implemented BOT registry to identify a set of one or more new BOTs, if any, each of which is capable of handling the current linguistic expression, the BOT registry storing information regarding a plurality of BOTs uploaded by one or more developers. The method further includes: automatically selecting a new BOT from the set without requiring the user to explicitly identify the new BOT as part of the current linguistic expression; and passing at least the current linguistic expression to the new BOT, as supplemented by the current state information, the current state information being formulated as an embellishment of the current linguistic expression. The method is implemented by a master BOT framework that provides a service to the current BOT and the plurality of BOTs in the BOT registry. Further, the master BOT framework is implemented, at least in part, using one or more machine-trained models. The method further includes generating, using a training system, the machine-trained model(s). The training system generates the machine-trained model(s) based at least on training examples associated with the plural BOTs, the training examples being provided by the BOT registry.

A twenty-first aspect corresponds to any combination (e.g., any logically consistent permutation or subset) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computing devices for facilitating interaction with plural computer-implemented BOTs, comprising:
hardware logic circuitry, the hardware logic circuitry corresponding to: (a) one or more hardware processors that perform operations by executing machine-readable instructions stored in a memory, and/or (b) one or more other hardware logic components that perform operations using a task-specific collection of logic gates, the operations including:
receiving, by a computer-implemented master BOT framework, an input signal that a user sends to a current BOT using an input device, the input signal expressing a current linguistic expression of the user, who is currently interacting with the current BOT to conduct a user-BOT dialogue;
determining, using an intent-monitoring component provided by the master BOT framework, current intent information that expresses a current intent associated with the current linguistic expression;
determining, using a context-monitoring component provided by the master BOT framework, current state information that expresses a current state of a BOT session being conducted by the user, the current state incorporating features regarding one or more prior turns, if any, of the user-BOT dialogue that are relevant to the current intent;
determining, using a routing component provided by the master BOT framework, and based on at least the current intent information, whether the current BOT is capable of handling the current linguistic expression;
upon determination that the current BOT cannot handle the current linguistic expression, using the routing component to query a computer-implemented BOT registry provided by the master BOT framework to identify a set of one or more new BOTs, if any, each of which is capable of handling the current linguistic expression, the BOT registry storing information regarding a plurality of BOTs uploaded by one or more developers;
selecting, using the routing component, a new BOT from the set; and
passing, using the routing component, at least the current linguistic expression to the new BOT, as supplemented by the current state information,
the routing component being communicatively coupled to the intent-monitoring component, the context-monitoring component, and the BOT registry of the master BOT framework.

2. The one or more computing devices of claim 1, wherein the new BOT is automatically chosen without requiring the user to explicitly identify the new BOT in the current linguistic expression.

3. The one or more computing devices of claim 1, wherein the current BOT is integrated with the master BOT framework, and wherein the master BOT framework relies on the current BOT to forward the BOT response, provided by the new BOT, to the user.

4. The one or more computing devices of claim 1, wherein the master BOT framework relies on the new BOT to directly send the BOT response to the user.

5. The one or more computing devices of claim 1, wherein the current state expresses information supplied by the user in one or more linguistic expressions, prior to the current linguistic expression.

6. The one or more computing devices of claim 1, wherein the current state expresses information supplied by one or more BOT responses, prior to the current linguistic expression.

7. The one or more computing devices of claim 1, wherein the master BOT framework uses, at least in part, one or more machine-trained models.

8. The one or more computing devices of claim 1, wherein the BOT registry includes a data store which stores sets of example linguistic expressions for respective BOTs, each set corresponding to linguistic expressions that an associated BOT is configured to handle.

9. The one or more computing devices of claim 1, wherein the processing operations further include generating, using a training system, one or more machine-trained models for use by the master BOT framework, the training system generating said one or more machine-trained models based at least on training examples associated with the plural BOTs, the training examples being provided by the BOT registry.

10. The one or more computing devices of claim 1, wherein said determining whether the current BOT is capable of handling the current linguistic expression is also based on a confidence score provided by the current BOT.

11. The one or more computing devices of claim 1,
wherein the BOT registry includes a first BOT selection component that is configured to select the set of BOTs, each of which is capable of handling the current linguistic expression, and
wherein the routing component includes a second BOT selection component for performing said selecting of the new BOT from among the set.

12. The one or more computing devices of claim 11, wherein the first BOT selection component and/or the second BOT selection component take into consideration a BOT-related preference of another user, the other user having a predetermined relation with the user who provided the current linguistic expression, the relation being defined by a social graph stored in a data store.

13. The one or more computing devices of claim 1, wherein at least some of the BOTs in the BOT registry are framework-agnostic BOTs that do not include logic that is specifically designed for interaction with the master BOT framework.

14. A method, implemented by one or more computing devices, for facilitating interaction with plural computer-implemented BOTs, comprising:
receiving, by a computer-implemented master BOT framework, an input signal that a user sends to a current BOT using an input device, the input signal expressing a current linguistic expression of the user, who is currently interacting with the current BOT to conduct a user-BOT dialogue;
determining, by the master BOT framework, current intent information that expresses a current intent associated with the current linguistic expression;
determining, by the master BOT framework, current state information that expresses a current state of a BOT session being conducted by the user, the current state incorporating features regarding one or more prior turns, if any, of the user-BOT dialogue that are relevant to the current intent;
determining, using a routing component provided by the master BOT framework, and based on at least the current intent information, whether the current BOT is capable of handling the current linguistic expression;
upon determination that the current BOT cannot handle the current linguistic expression, using the routing component to automatically query a computer-implemented BOT registry provided by the master BOT framework to identify a set of one or more new BOTs, if any, each of which is capable of handling the current linguistic expression, the BOT registry storing information regarding a plurality of BOTs uploaded by one or more developers;
automatically selecting, using the routing component, a new BOT from the set without requiring the user to explicitly identify the new BOT in the current linguistic expression; and
passing, by the routing component, at least the current linguistic expression to the new BOT, as supplemented by the current state information, the current state information being formulated as an embellishment of the current linguistic expression.

15. The method of claim 14, wherein the current BOT is integrated with the master BOT framework, and wherein the master BOT framework relies on the current BOT to forward the BOT response, provided by the new BOT, to the user.

16. The method of claim 14, wherein the master BOT framework relies on the new BOT to directly send the BOT response to the user.

17. The method of claim 14, wherein the current state expresses:
information supplied by the user in one or more linguistic expressions, prior to the current linguistic expression; and/or
information supplied by one or more BOT responses, prior to the current linguistic expression; and/or
information associated with the user obtained from one or more data stores.

18. The method of claim 14,
wherein the master BOT framework is implemented, at least in part, using one or more machine-trained models, and
wherein the method further includes generating, using a training system, said one or more machine-trained models,
the training system generating said one or more machine-trained models based at least on training examples associated with the plural BOTs, the training examples being provided by the BOT registry.

19. The method of claim 14, wherein at least some of the BOTs in the BOT registry are framework-agnostic BOTs that do not include logic that is specifically designed for interaction with the master BOT framework.

20. A computer-readable storage medium for storing computer-readable instructions, the computer-readable instructions, when executed by one or more hardware processors, performing a method that comprises:
receiving an input signal that a user sends to a current BOT using an input device, the input signal expressing a current linguistic expression of the user, who is currently interacting with the current BOT to conduct a user-BOT dialogue;
determining current intent information that expresses a current intent associated with the current linguistic expression;
determining current state information that expresses a current state of a BOT session being conducted by the user, the current state incorporating features regarding one or more prior turns, if any, of the user-BOT dialogue that are relevant to the current intent;
determining based on at least the current intent information, whether the current BOT is capable of handling the current linguistic expression;
upon determination that the current BOT cannot handle the current linguistic expression, automatically querying a computer-implemented BOT registry to identify a set of one or more new BOTs, if any, each of which is capable of handling the current linguistic expression, the BOT registry storing information regarding a plurality of BOTs uploaded by one or more developers;
automatically selecting a new BOT from the set without requiring the user to explicitly identify the new BOT as part of the current linguistic expression; and
passing at least the current linguistic expression to the new BOT, as supplemented by the current state information, the current state information being formulated as an embellishment of the current linguistic expression,
the method being implemented by a master BOT framework that provides a service to the current BOT and the plurality of BOTs in the BOT registry,
the master BOT framework being implemented, at least in part, using one or more machine-trained models,
the method further including generating, using a training system, said one or more machine-trained models,
the training system generating said one or more machine-trained models based at least on training examples associated with the plural BOTs, the training examples being provided by the BOT registry.
